(19) United States
(12) Patent Application Publication
(10) Pub. No.: US 2025/0165912 A1
(43) Pub. Date: May 22, 2025

(54) SYSTEM AND METHOD FOR IMPLEMENTING SURCHARGES IN TRUCKING INDUSTRY

(71) Applicant: Satish JINDEL, Warrendale, PA (US)

(72) Inventor: Satish JINDEL, Warrendale, PA (US)

(21) Appl. No.: 18/975,228

(22) Filed: Dec. 10, 2024

Related U.S. Application Data
(63) Continuation of application No. 18/338,799, filed on Jun. 21, 2023, now abandoned.

(51) Int. Cl. G06Q 10/0834; G06Q 30/04

(52) U.S. Cl. CPC G06Q 10/08345; G06Q 30/04

(57) ABSTRACT

A computer-implemented method and non-transitory computer-readable medium for pricing transportation service. A travel cost is priced to a shipper for transporting a load by a vehicle. Impact information is accessed, in real-time, relating to changes in speed of the vehicle, wherein the impact information includes weather impact data, infrastructure impact data and accident impact data. A surcharge is calculated and invoiced provided the impact information is present, and the surcharge is implemented into the travel costs, thereby forming a total travel cost which may be greater than the initial quote.

### CROSS-REFERENCE TO RELATED APPLICATIONS

The present application is a continuation-in-part of application Ser. No. 18/338,799, filed Jun. 21, 2023, the contents of which are incorporated by reference.

### FIELD OF THE INVENTION

The present invention relates to a system and method for pricing truckload service. In particular, the instant pricing structure accounts for extrinsic factors that are outside control of the carriers and the drivers but impact drivers' ability to travel at the expected speed limit used to determine the rate per mile used to pay truck drivers.

### BACKGROUND OF THE INVENTION

The nature of the truckload industry is such that workers who operate the trucks used to transport goods have to travel hundreds and thousands of miles. That makes it very difficult to monitor their productivity and impractical to pay the drivers by the hour. Hence, the industry relies on a decades old method of paying the drivers by the miles driven and operated on the approved route between the origin and destination addresses.

Therefore, the current method for pricing in the truckload industry is primarily based on per mile rate per trip with the actual distance determined using various mileage calculation sources such as PC Milage Maker, Google maps, etc. The per mile rate is determined using the speed of travel on highways and the expected number of hours it would take to travel the distance. The mileage calculation sources like google maps also show the travel time for a given distance and route. Using total miles and the estimated hours for the particular route, trucking companies offer their services on a per mile rate basis to shippers, brokers, third party logistics companies (3PL). In addition to covering the labor cost, the per mile rate is determined to cover the carriers' capital cost for ownership of the tractor, trailer, fuel, insurance, benefits for driver, tolls along the journey and other such items. The trucking industry later agreed to use the U.S. Department of Energy price for fuel that is updated periodically to establish a fuel surcharge, which is then applied as a percent of total shipping charges, then added to the total mile cost, as further explained.

However, in the last few years, the nation has been experiencing more severe weather challenges with hurricanes, tornadoes, earthquakes, volcanic eruptions, winter snow storms and dust blizzards or other similar events that have impacted ability for vehicular traffic to keep moving at the approved speed limit. This is especially true when it results in not only inches but feet or more of snow or major dust accumulation making driving conditions on highways during such conditions very treacherous and thereby unsafe for truck drivers and the general public in passenger cars.

With drivers getting paid by the mile and drivers required to stop driving after 10 hours behind the wheel for compliance with Federal Motor Carriers Safety Administration (FMCSA) mandated Hours of Service rules, they need to cover certain distance within a specified time-period. This results in drivers taking chances on their journey to keep moving on the highways at the higher than safe speed limit when they should slow down or pull into a rest area or a truck stop until weather conditions get better or road delays are cleared.

This extra time for transporting that load comes at the expense of the truck driver who is now spending more time for the same amount of pay. And, if it is owner-operators (using their own tractor and trailer), then it results in more money spent on diesel fuel and other related expenses for being on the highways for extra hours.

A shipper's ability to modify transportation cost quotations is known in the art. U.S. Pat. Publication No. 20190318311 to Chen teaches using up-to-date transport data to revise a shipping quote. However, in Chen, the quote is revised prior to transport and before the quote is accepted. Whereas, here, the invention is not revising the quote in real time, but rather transportation impact information is being accessed in real time that will allow the carriers to apply a surcharge related to events that can only be experienced after the load is in enroute and thus after the quote is accepted. Surcharges for weather, accident or infrastructure are unpredictable months or weeks in advance when the quote is submitted. Chen's quote modifications are not added as post-quote surcharges.

There is a need then for a computer-implemented system and method of including surcharges within the travel cost pricing model for trucking transportation services, as follows.

### SUMMARY OF THE INVENTION

It is the objective of the present invention to enhance safety of the truck driver, safety of other passenger traffic sharing the highway and roads with the trucks, and safety and security of the cargo, thereby avoiding serious damage to the tractor and trailers, and preventing highways and roads from getting totally blocked with a jackknifed tractor trailer for emergency vehicles like ambulances and police vehicles to pass through.

It is further an objective to have an impact on the reduction in the speed of travel and thereby enhanced safety in the transportation of the cargo and the general public in traveling from origin city to a destination. (The cost of travel will actually increase and not decrease).

It is further an objective to promote greater safety with truck traffic on national highways and roads.

It is further an objective to regulate the implementation of these surcharges, which will ensure compliance by shippers, carriers and all other parties like brokers and 3PLs for safety of drivers and the general public sharing the highways.

It is further an objective to enhance the ability of police departments to impose penalties and fines on drivers for ignoring speed limits on driving to ensure compliance with traffic regulations and promote safety of all vehicles and the public.

It is further an objective to give the carriers a better means of compensating the drivers for challenges that result from the various factors outside their control but now measurable with real time access to applicable data.

Accordingly, comprehended is, within a transportation management system of a carrier, a computer-implemented method and non-transitory computer-readable medium for pricing transportation service, comprising the steps of: receiving a bid from a shipper; quoting the bid; pricing a travel cost to a shipper for transporting a load by a vehicle, wherein the pricing further comprises the steps of: determining an initial travel cost; after the quote is accepted and during transport of the load, accessing, in real-time, impact information relating to changes in speed of said vehicle, wherein the impact information includes weather impact data (i.e. a weather delay surcharge (WSC), infrastructure impact data (ISC) and accident impact data (ASC); calculating, via a processor in the transportation management system, either of the WSC, ISC or ASC provided the impact information is present; displaying either of the WSC, ISC or ASC to the carrier; and, implementing the surcharge into said travel costs provided the impact information is present, thereby forming a total travel cost; wherein the total travel cost is greater than the initial travel cost, thereby improving the transportation management system; and, billing for the total travel cost. The invention is further well-suited for use on a mobile device, as follows.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows a flow chart for the prior art method of pricing truckload service.

FIG. 2 shows a flow chart for the instant method of pricing truckload service.

FIG. 3 shows detailed flow for accounting for a weather delay.

FIG. 4 shows detailed flow for accounting for infrastructure construction delay and major accident delay.

FIG. 5 shows an example invoice for pricing and invoicing a truckload service using this methodology.

Wherever possible, the same reference numbers will be used throughout the drawings to represent the same parts.

### DETAILED DESCRIPTION OF THE INVENTION

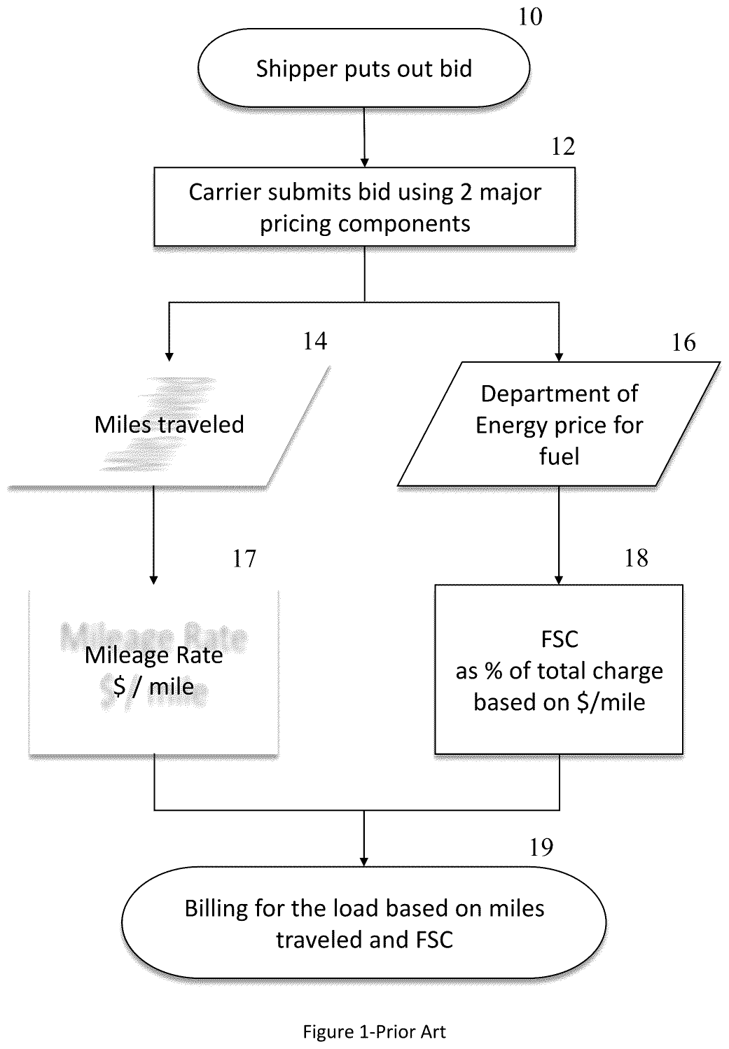

With reference to FIG. 1, the nature of the truckload industry is such that workers who operate the trucks used to transport goods have to travel hundreds and thousands of miles. That makes it very difficult to monitor their productivity and impractical to pay the drivers by the hour. Hence, the industry relies on a decades old method of paying the drivers by the miles driven and operated on the approved route between the origin and destination addresses. A shipper puts out a bid or request for quote (“RFQ”) to a carrier for the use of carrier's service 10. The carrier submits its own quote/bid using two major pricing components 12. The pricing components include miles traveled 14 and energy price 16.

Therefore, the prior art method for pricing in the truckload industry is primarily based on per mile rate per trip 17 with the actual distance determined using various mileage calculation sources such as PC Milage Maker, Google maps, etc. In addition, the per mile rate is determined using the speed of travel on highways and the expected number of hours it would take to travel the distance. Next, the mileage calculation sources like google maps also show the travel time for a given distance and route. Using total miles and the estimated hours for the particular route, trucking companies offer their services on a per mile rate basis to shippers, brokers, third party logistics companies (3PL). In addition to covering the labor cost, the per mile rate is determined to cover the carriers' capital cost for ownership of the tractor, trailer, fuel, insurance, benefits for driver, tolls along the journey and other such items.

After labor cost, fuel represents the second highest cost for trucking. So, in 1973, when the Arab countries put an oil embargo and suddenly raised the price of gasoline, the trucking industry sought and the shippers accepted a mechanism for reimbursing the carriers for such huge fluctuation in fuel price outside the control of the carriers and subject to changes on a weekly basis and without notice and thus eliminating the ability to incorporate those changes in the annual bids. The industry agreed to use Department of Energy price for fuel that is updated periodically to establish the surcharge. This surcharge, termed herein “energy price”, is applied as a percent of total shipping charges 18.

So, for illustration, a truck driver transporting a load from Philadelphia to Indianapolis would be paid an amount to $1,434.40 using total distance of 652 miles and a per mile rate of $2.00. In addition, a fuel surcharge (provided at the time of bidding) will be added to the invoice sent to the customer. And, if the route includes driving on toll road (e.g., Pennsylvania Turnpike in this instance for part of the distance), the driver would be reimbursed for that expense on submission of the toll receipts. Thus, the load is billed for based on miles traveled and fuel surcharge 19.

However, the nation experiences severe weather challenges with hurricanes, tornadoes, earthquakes, volcanic eruptions, winter snowstorms and dust blizzards or other similar events that have impacted ability for vehicular traffic to keep moving at the approved speed limit. Occasionally, this results in not only inches but feet or more of snow or major dust storms, thereby making driving conditions on highways during such conditions very treacherous and thereby unsafe for truck drivers and the general public in passenger cars.

With drivers getting paid by the mile and drivers required to stop driving after 10 hours behind the wheel for compliance with Federal Motor Carriers Safety Administration (FMCSA) mandated Hours of Service rules, they need to cover certain distance within a specified time period. This results in drivers taking chances on their journey to keep moving on the highways at the maximum allowed speed and ignoring the slower and safer speed limits for that stretch of the journey or to even pull into a rest area or a truck stop until weather conditions get better or road delays are cleared.

Ideally, in bad weather, the truck drivers should be driving at the reduced safe speed limit (say, 10 miles per hour) instead of the maximum speed limits (say 55 miles per hour). This does not happen because travelling at slower speed takes up more hours for the journey which means more hours spent on that trip for same total amount received for the trip, thus getting lower pay per hour. Also, limited is the ability to complete the trip without violating the FMCSA mandated Hours of Service rules. This extra time for transporting that load comes at the expense of the truck driver who is now spending more time for the same amount of pay. And, if it is owner-operators (using their own tractor and trailer), then it results in more money spent on diesel fuel and other related expenses for being on the highways for extra hours.

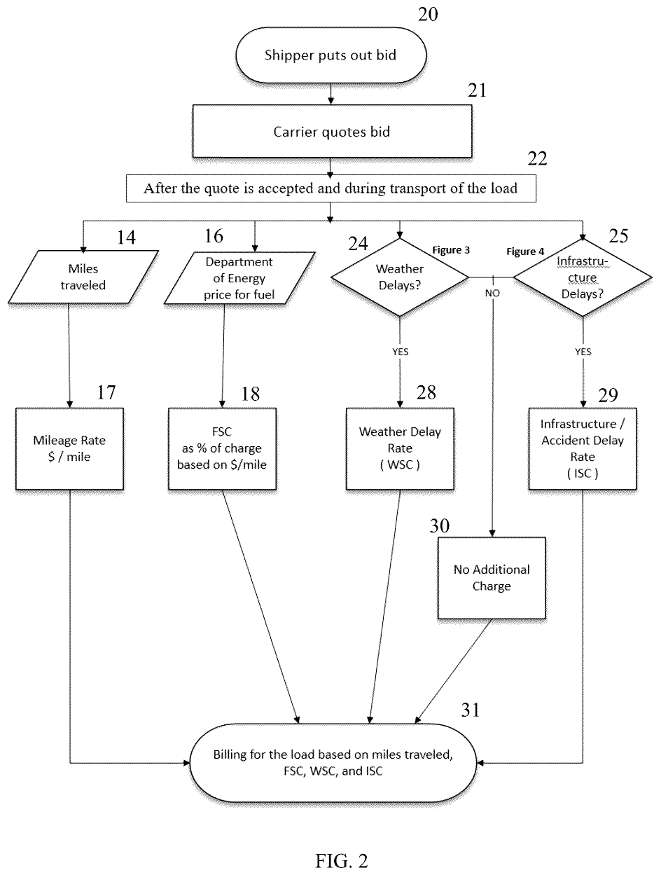

Now, with reference to FIGS. 2-4, embodiments and the operations shown in these drawings and described in this specification for the instant system and method are computer-implemented systems and methods. This means it can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including, by way of example, a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example, an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with or through a server. In the preferred embodiment herein, the client is a mobile device which carries out the process, which can be done at a remote location.

The FIG. 2-4 methodology is implemented as above with associated hardware. A controller system is the computer or the client mobile device collecting data from a data collection system, storing the data in a memory system, and generating reports on a reporting system. The controller system, data collection system, memory system, and reporting system may all be embodied as an app running on one or more general purpose portable computing device such as a smartphone, tablet computer, or laptop computer or may take the form of a distributed computing system implemented by a number of separate devices, at least a portion of which is accessible over the internet (e.g., cloud-based computing and via application programming interfaces (API) and electronic data interchange (EDI) data formats). It should be known a computer program is an executable program of instructions which can be executed on one computer or on multiple computers that are located at one site or distributed across multiple sites and interconnected by a communication network. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry. Additionally, processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment.

Having described the hardware, the proposed method is about enhancing a decades old pricing structure for the truckload and intercity trucking to recognize the numerous changes in technology that have made it practical to gain real time access of information relating to changes in speed on limited access highways and all other types of roads resulting from bad weather, construction and major accidents. Just as the industry implemented fuel surcharges to address impact on fuel price that is outside the control of the trucking companies and drivers, the proposed method provides for implementation of surcharge for other factors that are outside the control of the carriers and the drivers but impact drivers' ability to travel at the expected speed limit used to determine the rate per mile used to pay the truck drivers and to charge the shippers for the transportation service. A few of such factors that have been ignored for decades but need to be addressed include: weather, infrastructure related highway and bridge reconstruction projects and major accidents that result in fewer traffic lanes and/or reduced speed limit on portions of the journey. As such, here, a shipper puts out a bid to a carrier for the use of carrier's service 10, received by carrier. “Shipper” means the user of the carrier service desirous of transporting goods from one location to another, e.g. to a recipient who orders and receives the goods. “Carrier” is the actual trucking service provider offering the physical transportation services (using its vehicles from origin to destination), to shippers, brokers, and third-party logistics companies, thus the instant system and method is well-suited to be implemented within the shippers' and carriers' transportation management systems, thereby improving the transportation management system of the carrier.

Herein, the shipper puts out a bid 20. In response to shipper's bid or RFQ, the carrier submits its bid/quote 21. The quote contains the pricing for the two major pricing components, but also contains additional provisions allowing for surcharges related to weather delays and infrastructure delays, thereby forming an initial travel cost. Thus, after the quote is accepted and during transport of the load 22 an initial travel cost (for invoicing purposes) is subject to addition by including surcharges. The pricing components for a total travel cost include miles traveled 14, fuel price 16, then provisions for weather impact data in the form of weather delays 24 and infrastructure impact data in the form of infrastructure delays and major accident related delays impacting speed limits and travel times 25. The initial pricing includes but is not primarily based on per mile rate per trip 17 with the actual distance determined using various mileage calculation sources such as PC Milage Maker, Google maps, etc. In addition, the per mile rate is determined using the speed of travel on highways and the expected number of hours it would take to travel the distance. Next, the mileage calculation sources like google maps also show the travel time for a given distance and route. Using total miles and the estimated hours for the particular route, trucking companies offer their services on a per mile rate basis to shippers, brokers, third party logistics companies (3PL). In addition to covering the labor cost, the per mile rate is determined to cover the carriers' capital cost for ownership of the tractor, trailer, fuel, insurance, benefits for driver, tolls along the journey and other such items.

After labor cost, since the industry agreed to use Department of Energy price for fuel that is updated periodically to establish the surcharge. This surcharge is applied as a percent of total shipping charges 18.

Next, here, and as further discussed, the proposed method for new surcharges recover cost factors related to weather delays 24 and infrastructure delays 25 to supplement the initial pricing. A weather delay rate 28, i.e. weather surcharge (WSC), is established as is an infrastructure/accident delay rate 29, i.e. infrastructure surcharge (ISC), provided such exists, else there would be no additional charge 30. Therefore, after the quote is accepted and during transport of the load, a total travel cost (for invoicing) now may include all WSC, ISC or ASC surcharges being applied and the total travel cost, revised from the initial travel cost, is billed for 31.

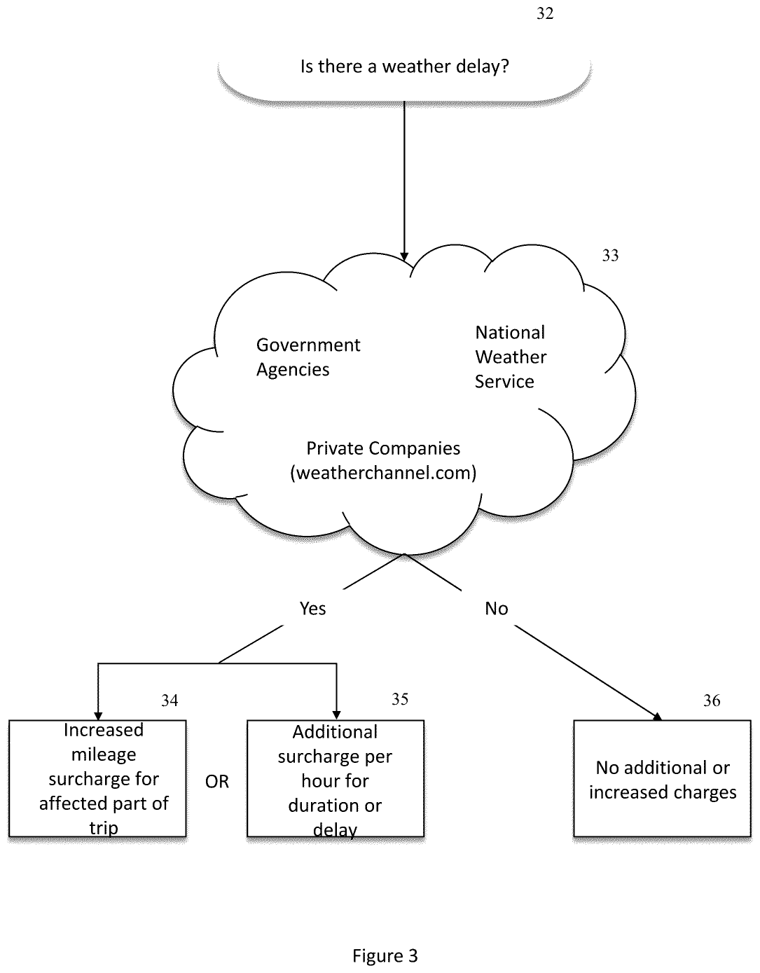

With particular reference to FIG. 3, weather impact data is weather-related elements which impact speed of travel and are implemented as follows, thereby forming a weather delay surcharge (WSC). The proposed method for new surcharges to recover cost factors outside the control of the trucking companies and their drivers due to bad weather would be managed and determined using the real time, daily or weekly (as relevant) reports, termed herein “weather reports”, available via various local, state and federal agencies, police departments, national weather service of the U.S. Government and private companies like weatherchannel.com (i.e. web API or EDI) which address the issue of whether there are current or perspective weather delays 32, 33. The trucking companies would submit total travel cost invoices to handle loads to include not just cost per mile and fuel surcharge, but also a rate per hour or higher rate per mile for the applicable section of the travel route to recover the time lost by driver from such weather-related delays, 34, 35, else there would no additional increased charges.

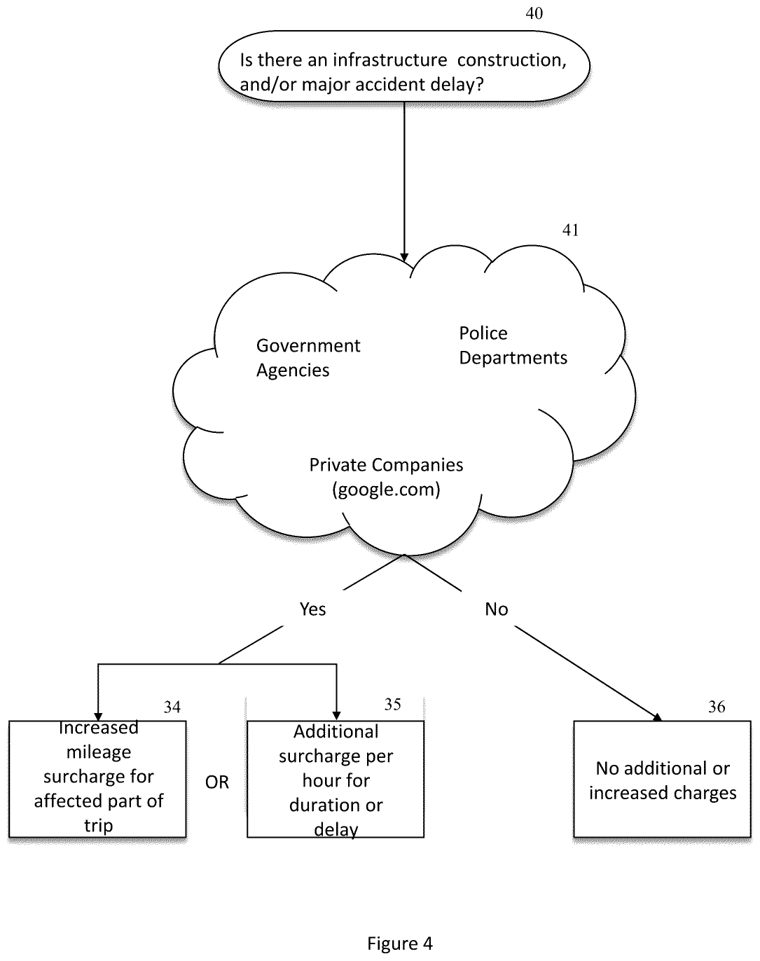

With particular reference to FIG. 4, infrastructure related elements which impact speed of travel are implemented as follows. Impact information can be the WSC above, or, as here, infrastructure impact data (ISC) and accident impact data (ASC). Within this platform or module, the WSC, ISC or ASC takes the form of data received from the source, which can be pulled by “look-up”, or each source can provide the Application Programming Interfaces (APIs) that allows the platform to vertically integrate. The proposed method for new surcharges to recover cost factors outside the control of the trucking companies and their drivers due to construction and major accidents would be managed and determined using the real time, daily or weekly (as relevant) reports available via various local, state and federal agencies, police departments and even private sources like Google and Apple, termed herein “agency reports”, which address the issue of whether there are current or perspective infrastructure delays 40, 41. The use of impact information means “infrastructure delay” or “infrastructure impact data” (ISC) but also means delays related to increased traffic whether or not a result of actual, physical infrastructure impacts, thus accident impact data surcharge (ASC). Either of the looked-up or integrated WSC, ISC or ASC is displayed to the carrier, which can then be implemented into the trucking company invoice. The trucking companies would submit bids to handle loads to include not just cost per mile and fuel surcharge, but also be subject to a rate per hour or higher rate per mile for the applicable section of the travel route to recover the time lost by driver from such construction and major accident-related delays 42, 43, else there would no additional increased charges. Thus, the total travel cost might be greater than the initial travel cost, the former of which can now be billed for.

The benefits of the proposed surcharges are many including: safety of truck driver, safety of other passenger traffic sharing the highway and roads with the trucks, safety and security of the cargo, avoiding serious damage to the tractor and trailers, and preventing highways and roads from getting totally blocked with a jackknifed tractor trailer for emergency vehicles like ambulances and police vehicles to pass through.

The impact of reduction in the speed of travel and thereby cost of transporting a load from origin city to a destination is almost entirely borne by the truck driver, and thereby truck drivers have a tendency to keep driving when they should pull over and wait or slow down. If the cost of such extra travel time was borne by the shippers, it would remove the burden from the drivers and promote greater safety with truck traffic on national highways and roads. With FMCSA having responsibility to promote safe driving by motor carriers that resulted in establishment of Hours of Service (HOS) regulations, the proposed method also provides a compelling basis for regulating the implementation of these surcharges, which will ensure compliance by shippers, carriers and all other parties like brokers and 3PLs for safety of drivers and general public sharing the highways.

The instant method for design and pricing of truckload service gives the carriers a better means of compensating the drivers for challenges that result from the various factors outside their control but now measurable with real time access to applicable data. It will reduce the number of accidents and severity of accidents that occur when truck drivers keep operating at the higher posted speed limit, reduce the cost incurred by state police departments to clear roads and highways that get blocked when trucks slide off the road and injure people.

With the implementation of such surcharge, it will also enhance the ability of police departments to impose penalty and fine on drivers for ignoring speed limits on driving to ensure compliance with traffic regulations and promote safety of all vehicles and the public.

### Example

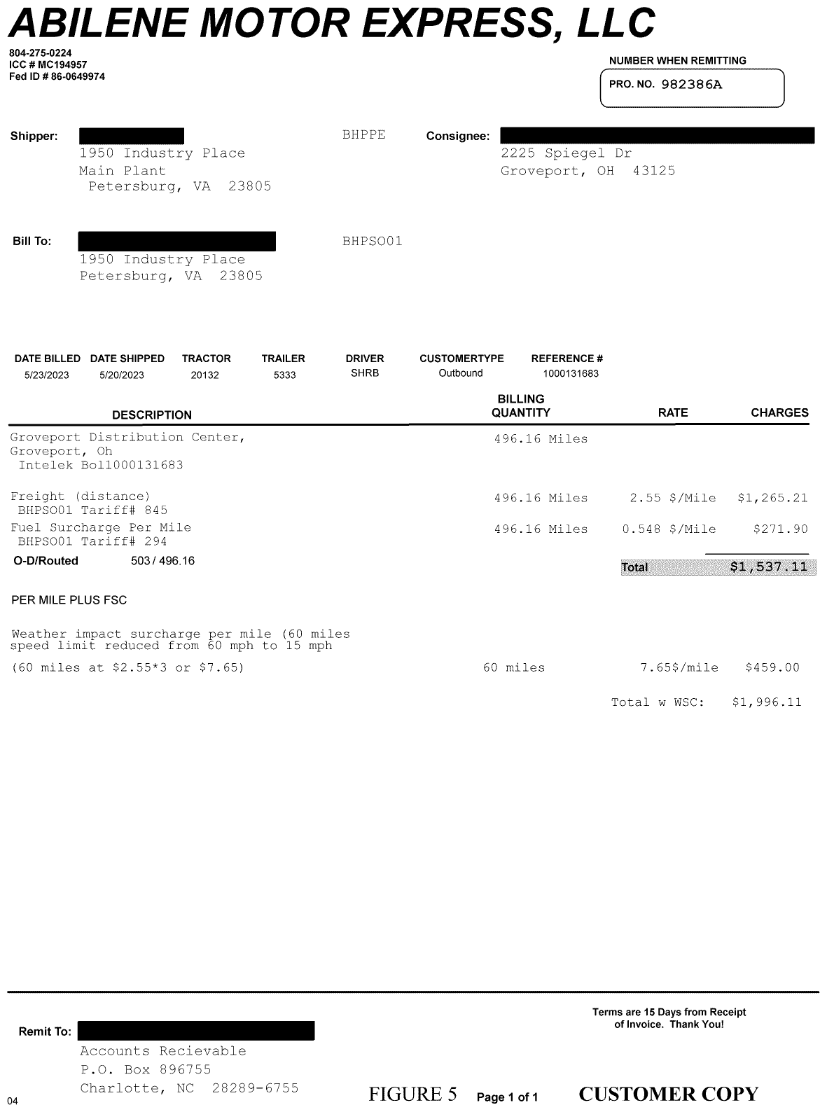

### See FIG. 5.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. In a transportation management system of a carrier, a computer-implemented method for pricing transportation service, comprising the steps of:
receiving a bid from a shipper;
quoting said bid;
pricing a total travel cost to said shipper for transporting a load by a vehicle, wherein the step of pricing further comprises the steps of:
determining an initial travel cost;
after the step of quoting said bid and during transport of said load, accessing, in real-time, impact information relating to potential changes in speed of said vehicle, wherein said impact information includes weather impact data and infrastructure impact data retrieved and stored from a web service, wherein said weather impact data includes weather-related elements which impact said vehicle, said weather-related elements determined by accessing weather reports to thereby form a weather delay surcharge (WSC), and wherein said infrastructure impact data includes construction and accident-related delays, said construction and accident-related delays determined by accessing agency reports to thereby form an infrastructure delay surcharge (ISC) and major accident related delay surcharge (ASC);
calculating, via a processor in said transportation management system, either of said WSC, said ISC or said ASC provided said impact information is present;
displaying either of said WSC, said ISC or said ASC to said carrier;
implementing either of said WSC, said ISC or said ASC into said initial travel cost, thereby forming a total travel cost, wherein said total travel cost is greater than said initial travel cost, thereby improving said transportation management system; and,
displaying said total travel cost.

2. The method of claim 1, further comprising the step of billing said shipper for said load inclusive of said total travel cost.

3. The method of claim 1, wherein said initial travel cost is determined based on a per mile rate per trip calculation plus a fuel surcharge price.

4. For a transportation management system of a carrier, a non-transitory computer-readable medium with stored contents that cause one or more computing devices to perform the steps of:
receiving a bid from a shipper;
quoting said bid;
pricing a total travel cost to said shipper for transporting a load by a vehicle, wherein the step of pricing further comprises the steps of:
determining an initial travel cost;
after the step of quoting said bid and during transport of said load, accessing, in real-time, impact information relating to potential changes in speed of said vehicle, wherein said impact information includes weather impact data and infrastructure impact data retrieved and stored from a web service, wherein said weather impact data includes weather-related elements which impact said vehicle, said weather-related elements determined by accessing weather reports to thereby form a weather delay surcharge (WSC), and wherein said infrastructure impact data includes construction and accident-related delays, said construction and accident-related delays determined by accessing agency reports to thereby form an infrastructure delay surcharge (ISC) and major accident related delay surcharge (ASC);
calculating, via a processor in said transportation management system, either of said WSC, said ISC or said ASC provided said impact information is present;
displaying either of said WSC, said ISC or said ASC;
implementing either of said WSC, said ISC or said ASC into said initial travel cost, thereby forming a total travel cost, wherein said total travel cost is greater than said initial travel cost, thereby improving said transportation management system; and,
displaying said total travel cost.

5. The medium of claim 4, further comprising the step of billing said shipper for said load inclusive of said total travel cost.

6. The medium of claim 4, wherein said initial travel cost is determined based on a per mile rate per trip calculation plus an energy price.

7. In a transportation management system of a carrier, a computer-implemented method for pricing transportation service, comprising the steps of:
receiving a bid from a shipper;
quoting said bid;
using a mobile device, pricing a total travel cost to said shipper for transporting a load by a vehicle, wherein the step of pricing further comprises the steps of:
determining an initial travel cost;
after the step of quoting said bid and during transport of said load, accessing, in real-time, impact information relating to potential changes in speed of said vehicle, wherein said impact information includes weather impact data and infrastructure impact data retrieved and stored from a web service, wherein said weather impact data includes weather-related elements which impact said vehicle, said weather-related elements determined by accessing weather reports to thereby form a weather delay surcharge (WSC), and wherein said infrastructure impact data includes construction and accident-related delays, said construction and accident-related delays determined by accessing agency reports to thereby form an infrastructure delay surcharge (ISC) and major accident related delay surcharge (ASC);
calculating, via a processor in said transportation management system, either of said WSC, said ISC or said ASC provided said impact information is present;
displaying either of said WSC, said ISC or said ASC on said mobile device;
implementing either of said WSC, said ISC or said ASC into said initial travel cost, thereby forming a total travel cost, wherein said total travel cost is greater than said initial travel cost, thereby improving said transportation management system; and,
displaying said total travel cost on said mobile device.

8. The method of claim 7, further comprising the step of billing said shipper for said load inclusive of said total travel cost.

9. The method of claim 7, wherein said initial travel cost is determined based on a per mile rate per trip calculation plus an energy price.
